(19) United States
(12) Patent Application Publication
(10) Pub. No.: US 2026/0041118 A1
(43) Pub. Date: Feb. 12, 2026

(54) COMPOSITE PLANT PROTEIN AND PREPARATION METHODS THEREOF

(71) Applicants: NANCHANG UNIVERSITY, Nanchang (CN); INTERNATIONAL INSTITUTE OF FOOD INNOVATION CO., LTD. OF NANCHANG UNIVERSITY, Nanchang (CN)

(72) Inventors: Taotao DAI, Nanchang (CN); Jun CHEN, Nanchang (CN); Yunfeng LU, Nanchang (CN); Zhaoying LI, Nanchang (CN); Lizhen DENG, Nanchang (CN); Chengmei LIU, Nanchang (CN); Ti LI, Nanchang (CN); Ruihong LIANG, Nanchang (CN)

(73) Assignees: NANCHANG UNIVERSITY, Nanchang (CN); INTERNATIONAL INSTITUTE OF FOOD INNOVATION CO., LTD. OF NANCHANG UNIVERSITY, Nanchang (CN)

(21) Appl. No.: 18/796,277

(22) Filed: Aug. 6, 2024

(51) Int. Cl. A23J 3/14; A23J 3/16; A23L 5/30; A23L 29/00

(52) U.S. Cl. CPC A23J 3/14; A23J 3/16; A23L 5/32; A23L 29/015

(57) ABSTRACT

A method for preparing a composite plant protein, including: S1: mixing at least two kinds of plant proteins with water, adding compound alkali powder to a mixed solution and stirring, so as to obtain a protein stock solution with a pH of 10-10.5; the two kinds of plant proteins being rice protein and pea protein, or the rice protein and soy protein; and the compound alkali powder is sodium hydroxide and calcium hydroxide; S2: obtaining a protein solution with a pH of 6.8-7.0 by performing a high-pressure jet mill-ultrasonic treatment on the protein stock solution obtained from step S1, and adding citric acid to a treated protein stock solution; and S3: obtaining the composite plant protein by spray-drying the protein solution obtained from step S2.

### TECHNICAL FIELD

The present disclosure relates to a field of food processing technology, and in particular to a composite plant protein and a preparation method thereof.

### BACKGROUND

A share of plant protein in the current global diet is increasing every year.

Compared with an animal protein, the plant protein has advantages of being more accessible, low-carbon and environmentally friendly, and nutritious and healthy, which make the plant protein a popular raw material for new health foods. Rice protein has a wide range of sources, a low allergenicity, a high biomass price, and a reasonable amino acid structure in line with a nutritional pattern recommended by WHO/FAO, with essential amino acid scores of around 100. Pea protein and soy protein are both excellent plant proteins that are not only rich in a variety of essential amino acids but are also inexpensive and highly nutritious. There are common advantages between the rice protein and these two legume proteins, and a functional complementarity may be achieved. For example, the rice protein has better raw material price and digestibility, a higher sulphur-containing amino acid content, and the pea protein and the soy protein have relatively better functional properties and are rich in lysine.

In an actual production, a performance of the plant protein is generally difficult to meet an actual need of a production process, a low solubility is a key technical difficulty in industrialization and productization of the plant protein. Due to an inability to be uniformly dispersed in water, the plant protein may not be further applied to, for example, emulsions, colloids, foams and other food product systems, which seriously restricts an application scope of the plant protein, thereby binding a marketization process=of the plant protein. The current manners of plant protein modification mainly include an enzymatic modification, a chemical modification and a physical modification.

The enzymatic modification has a good effect, but the protein is hydrolyzed into peptides and small molecular amino acids, which is unable to fully retain original nutritional properties of the protein and produces a bitter taste. The chemical modification such as a glycosylation modification, an acylation modification, and a phosphorylation modification are able to effectively improve a protein solubility, but a reaction of the modification process is difficult to control and may cause a food safety problem. The physical modification is able to completely retain a primary structure of the protein and does not require additional chemical reagents, but the modification effect of the physical modification is limited and a processing capacity cannot match requirements for industrial production.

Therefore, it is of great significance to develop a simple and efficient, green and safe, and industrialized plant protein modification technology to expand the market of the plant protein and break through a bottleneck of plant protein development.

### SUMMARY

One or more embodiments of the present disclosure provide a method for preparing a composite plant protein. The method may include: S1: mixing at least two kinds of plant proteins with water, adding compound alkali powder to a mixed solution and stirring, so as to obtain a protein stock solution with a pH of 10-10.5. The two kinds of plant proteins may be rice protein and pea protein, or the rice protein and soy protein; and the compound alkali powder may be sodium hydroxide and calcium hydroxide; S2: obtaining a protein solution with a pH of 6.8-7.0 by performing a high-pressure jet mill-ultrasonic treatment on the protein stock solution obtained from step S1, and adding citric acid to a treated protein stock solution; S3: obtaining the composite plant protein by spray-drying the protein solution obtained from step S2.

In some embodiments, step S1 may further be preceded by a pre-treatment that includes: pulverizing the at least two kinds of plant proteins to 300 mesh using a cryogenic impact mill. A frequency of the cryogenic impact mill may be 40 Hz and a temperature of the cryogenic impact mill may be 15° C.-25° C.

In some embodiments, a mass ratio of the sodium hydroxide to the calcium hydroxide may be 1:1.

In some embodiments, a temperature of the water in step S1 may be 45° C.-50° C.

In some embodiments, a mass ratio of the at least two kinds of plant proteins to the water may be (0.6-1):(9-9.4).

In some embodiments, a mass ratio of the rice protein to the pea protein, or a mass ratio of the rice protein to the soy protein, may be 1:1.

In some embodiments, a frequency of the high-pressure jet mill in step S2 may be 21 Hz-24 Hz and a pressure may be 120 MPa-160 MPa. A power of the ultrasonic treatment may be 300 W.

In some embodiments, a particle size of the composite protein in the protein solution in step S2 may be 25 μm-40 μm.

In some embodiments, the spray-drying in step S3 may be performed using a mist drying tower atomizer at a frequency of 45 Hz-50 Hz, with an inlet air temperature of 160° C.−175° C. and an outlet air temperature of 75° C.-85° C.

One or more embodiments of the present disclosure provide a composite plant protein prepared by the preparation method described above.

### BRIEF DESCRIPTION OF THE DRAWINGS

This description will be further explained in the form of exemplary embodiments, which will be described in detail by means of accompanying drawings. These embodiments are not restrictive, in which the same numbering indicates the same structure, wherein:

FIG. 1 is a diagram illustrating an exemplary high-pressure jet mill-ultrasonic treatment device according to some embodiments of the present disclosure.

### DETAILED DESCRIPTION

The technical schemes of embodiments of the present disclosure will be more clearly described below, and the accompanying drawings that need to be configured in the description of the embodiments will be briefly described below. Obviously, the drawings in the following description are merely some examples or embodiments of the present disclosure and will be applied to other similar scenarios according to these accompanying drawings without paying creative labor. Unless obviously obtained from the context or the context illustrates otherwise, the same numeral in the drawings refers to the same structure or operation.

As shown in the present disclosure and claims, unless the context clearly prompts the exception, “a,” “one,” and/or “the” is not specifically singular, and the plural may be included. It will be further understood that the terms “comprise,” “comprises,” and/or “comprising,” “include,” “includes,” and/or “including,” when used in present disclosure, specify the presence of stated features, integers, steps, operations, elements, and/or components, but do not preclude the presence or addition of one or more other features, integers, steps, operations, elements, components, and/or groups thereof.

One of the embodiments of the present disclosure provides a method for preparing a composite plant protein. The method may include: S1: mixing at least two kinds of plant proteins with water, adding compound alkali powder to a mixed solution and stirring, so as to obtain a protein stock solution with a pH of 10-10.5; the two kinds of plant proteins being rice protein and pea protein, or the rice protein and soy protein; and the compound alkali powder being sodium hydroxide and calcium hydroxide; S2: obtaining a protein solution with a pH of 6.8-7.0 by performing a high-pressure jet mill-ultrasonic treatment on the protein stock solution obtained from step S1, and adding citric acid to a treated protein stock solution; and S3: obtaining the composite plant protein by spray-drying the protein solution obtained from step S2.

Step S1: mixing at least two kinds of plant proteins with water, adding compound alkali powder to a mixed solution and stirring.

In some embodiments, the plant protein may include the rice protein, the pea protein, and the soy protein. In some embodiments, the at least two plant proteins may be the rice protein and the pea protein, or the rice protein and the soy protein.

In some embodiments, a mass ratio of the rice protein to the pea protein, or a mass ratio of the rice protein to the soy protein, may be 1:1. When heterologous protein is introduced, the rice protein may form a composite structure with other protein molecules in a pH-restoring neutral stage of step S2, which is favorable for the protein to maintain a better water solubility, and a pairing of the soy protein with the rice protein may also provide an advantage in terms of amino acid proportioning, which complements the first limiting amino acid lysine of the rice protein.

In some embodiments, a water temperature in step S1 may be 45° C.-50° C. In some embodiments, the water temperature in step S1 may be 45° C., 46° C., 47° C., 48° C., 49° C., 50° C. A higher water temperature may be favorable for the protein powder to be rapidly dispersed in the water, and enhancing an activity of the protein molecules in the solution. However, when the temperature is higher than 60° C., the protein may be prone to denaturation. At the same time, an optimal water temperature may be 45° C.-50° C. as the treatment of the high-pressure jet mill leads to a certain degree of warming of the protein solution.

In some embodiments, a mass ratio of the two plant proteins to water may be (0.6-1):(9-9.4). In some embodiments, the mass ratio of the two plant proteins to the water may be 0.6:9.4, 0.8:9.2, 1:9, etc. If the mass ratio of the plant proteins to the water is low, the composite plant protein production efficiency may be low, and if the mass ratio of the plant proteins to the water is too high, an effect of the high-pressure jet mill-ultrasonic treatment may be affected.

In some embodiments, the compound alkali powder may be the sodium hydroxide and the calcium hydroxide. The compound alkali powder provided in embodiments of the present disclosure may avoid a problem of excessive sodium ion content in the finished protein powder caused when only the sodium hydroxide is used, so that the sodium ion content of the finished protein powder complies with national regulations. In some embodiments, the mass ratio of the sodium hydroxide to the calcium hydroxide may be 1:1.

In some embodiments, the compound alkali powder may be added so that the pH of the protein stock solution is 10-10.5. In some embodiments, the compound alkali powder may be added so that the pH of the protein stock solution is 10, 10.1, 10.2, 10.3, 10.4, 10.5, etc. If the pH of the protein stock solution is too low, the protein (especially the rice protein) may not be fully developed, a modification effect may be greatly weakened; if the pH of the protein stock solution is too high, the protein is prone to be hydrolyzed into peptides, thereby undermining an integrity of protein nutrition and causing a bad flavor. In addition, too much alkali may also increase a salt content in a final product.

Step S2: obtaining a protein solution with a pH of 6.8-7.0 by performing a high-pressure jet mill-ultrasonic treatment on the protein stock solution obtained from step S1, and adding citric acid to a treated protein stock solution.

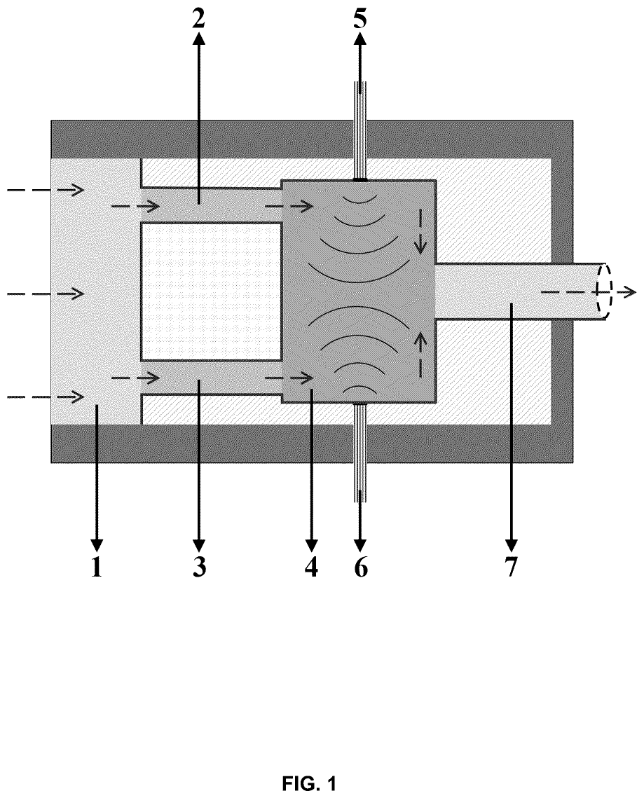

FIG. 1 is a diagram illustrating an exemplary high-pressure jet mill-ultrasonic treatment device according to some embodiments of the present disclosure. The high-pressure jet mill-ultrasonic treatment device may be an integrated device. A process of protein stock solution through the high-pressure jet mill-ultrasonic treatment may be as follows: the protein stock solution may firstly pass through an inlet pipe region 1, then pass through diverter pipe regions 2 and 3, and then a jet chamber 4 (with ultrasonic probes 5 and 6 attached outside the chamber) may ultrasonically treat the protein stock solution flowing through an inner portion of the jet chamber, and after the ultrasonic treatment is finished, the protein stock solution may flow out through an outlet pipe region 7, so as to complete the high-pressure jet mill-ultrasonic treatment to obtain the protein solution.

In some embodiments, a frequency of the high-pressure jet mill in step S2 may be 21 Hz-24 Hz, a pressure of the high-pressure jet mill may be 120 MPa-160 MPa; and a power of the ultrasonic treatment may be 300 W. In some embodiments, the frequency of the high-pressure jet mill in step S2 may be 22 Hz, the pressure may be 120 MPa; and the power of the ultrasonic treatment may be 300 W. In some embodiments, the frequency of the high-pressure jet mill in step S2 may be 23 Hz, the pressure may be 130 MPa; and the power of the ultrasonic treatment may be 300 W.

Compared to treating the protein solution with a high-pressure jet mill and an ultrasound separately, combining the two treatments may have at least the following advantages: on the one hand, a working time may be shortened, and a cost may be reduced; on the other hand, a huge energy generated by the jet in an impaction chamber may induce a transformation of a basic protein structure, and the energy provided by the ultrasonic treatment may be more likely to act on critical sites of the proteins in such a state. Therefore, a synergistical effect of the high-pressure jet mill and the ultrasound may be superior to their individual effects.

The citric acid may then be added to adjust the pH of the protein solution after the high-pressure jet mill-ultrasonic treatment. In some embodiments, the citric acid may be added so that the pH of the protein solution is 6.8-7.0. In some embodiments, the citric acid may be added so that the pH of the protein solution may be 6.8, 6.9, 7.0, etc. Maintaining the pH of the protein solution neutral at this time may be conducive to a stabilization of the composite plant protein character; if the pH is acidic, the protein may be separated again; and if the pH is alkaline, application scenarios of the proteins may be limited.

In some embodiments, a particle size of the composite plant protein in the protein solution in step S2 may be 25 μm-40 μm. In some embodiments, the particle size of the composite plant protein in the protein solution in step S2 may be 25 μm, 27 μm, 30 μm, 33 μm, 40 μm.

A combining efficiency of heterologous protein in the solution system may be significantly enhanced at the particle size, resulting in a significant increase in a solubility of the composite protein.

S3: obtaining the composite plant protein by spray-drying the protein solution obtained from step S2.

In some embodiments, the spray-drying in step S3 may employ a mist drying tower atomizer with a frequency of 45 Hz-50 Hz, an inlet air temperature of 160° C.−175° C., and an outlet air temperature of 75° C.-85° C.

In some embodiments, the spray-drying in step S3 may employ the mist drying tower atomizer with a frequency of 45 Hz, an inlet air temperature of 180° C. and an outlet air temperature of 85° C.

In some embodiments, the spray-drying in step S3 may employ the mist drying tower atomizer with a frequency of 47 Hz, an inlet air temperature of 175° C. and an outlet air temperature of 80° C.

In some embodiments, the spray-drying in step S3 may employ the mist drying tower atomizer with a frequency of 43-45 Hz, w an inlet air temperature of 180° C. and an outlet air temperature of 83° C.

In some embodiments, the spray-drying in step S3 may employ the mist drying tower atomizer with a frequency of 48 Hz, an inlet air temperature of 180° C. and an outlet air temperature of 80° C.

In some embodiments, the spray-drying in step S3 may employ the mist drying tower atomizer with a frequency of 46 Hz, an inlet air temperature of 180° C. and an outlet air temperature of 80° C.

In some embodiments, the spray-drying in step S3 may employ the mist drying tower atomizer with a frequency of 46 Hz, an inlet air temperature of 179° C. and an outlet air temperature of 81° C.

In some embodiments, the spray-drying in step S3 may employ the mist drying tower atomizer with a frequency of 46 Hz, an inlet air temperature of 181° C. and an outlet air temperature of 81° C.

The spray-drying treatment may be efficient, and have a great capacity, which is suitable for industrialization. The effect of the spray-drying treatment may be better when the inlet air temperature and the outlet air temperature are within the above ranges. If the temperature is too high, the protein may be easily denatured and aggregated during the drying process, and if the temperature is too low, the production efficiency may not be guaranteed.

In some embodiments, step S1 may be further preceded by a pre-treatment that includes: pulverizing the at least two kinds of plant proteins to 300 mesh using a cryogenic impact mill; a frequency of the cryogenic impact mill being 40 Hz, and a temperature of the cryogenic impact mill being at a temperature of 15° C.-25° C. In some embodiments, the temperature of the cryogenic impact mill may be 15° C., 16° C., 17° C., 18° C., 19° C., 20° C., 21° C., 22° C., 23° C., 24° C., 25° C. The pre-pulverizing of the proteins to 300 mesh may effectively improve a processing efficiency of protein, so that the protein may be dissolved in the alkaline solution more quickly.

The embodiment of the present disclosure may adopt a mode of combining a chemical modification and a physical modification, take the rice protein, the pea protein, and the soy protein as raw materials. After processes of pre-pulverizing, mixing, alkali activation, high-pressure jet mill-ultrasonic treatment, protein recombination, spray-drying, etc., a high concentration and high-performance composite plant protein may be prepared. The embodiment of the present disclosure may mainly adopt the cryogenic impact mill to pre-pulverize the three kinds of proteins, add the compound alkali powder to adjust a protein solution environment to make the protein structure unfolding, then a jet-ultra ultrasonic treatment may be performed on the activated composite protein using a high-pressure jet mill-ultrasound. In the process, the alkali activation combined with an industrial-grade high-pressure jet mill and an ultrasonic treatment system may be used to regulate conformational changes of plant proteins, and then the pH of the protein solution may be adjusted to restore to neutral, thereby inducing a protein to recombine to generate a new protein structure, and finally the composite plant protein may be obtained by spray-drying. According to experimental data of the embodiments of the present disclosure, compared to the three kinds of plant protein raw materials, the composite plant protein prepared in the embodiments of the present disclosure may have a solubility of no less than 85%, an emulsifying property may be increased by approximately 80%, a foaming property may be increased by approximately 240%. Further, the composite plant protein may have excellent physicochemical properties, a treating concentration of no less than 6%, and a treating capacity of more than 1 t/h. A process framework of the alkali activation combined with the high-pressure jet mill-ultrasonic treatment of various plant proteins may solve problems of poor solubility and functional properties of the plant proteins as well as an incomplete nutrition, strongly broadens a development scope and ideas of the plant protein products, and meets the requirements of industrial production.

Another aspect of the present disclosure provides the composite plant protein obtained by the preparation method described above. Compared with natural plant protein, the composite plant protein provided in the embodiments of the present disclosure may have a solubility of no less than 85%, an emulsifying property increased by approximately 80%, a foaming property increased by approximately 240%, and a greatly improved functional property, which greatly expands the application scenarios of the composite plant protein.

Beneficial effects of embodiments of the present disclosure may include but not limited to, a method for preparing a composite plant protein with high concentration and high performance is provided. In this method, by regulating the conformational change of the plant proteins through the alkali activation combined with the industrial-grade high-pressure jet mill-ultrasonic treatment, the plant proteins may be recombined into a brand-new molecular system, which solves problems of poor dispersion and nutritional deficiencies of the rice protein and two kinds of legume proteins. A wet-physical modification device used in this method, i.e., the high-pressure jet mill, may have characteristics of a great treatment capacity, a high treatment pressure, a good physical modification effect, etc. The treatment pressure may be 0 MPa-160 MPa, and the ultrasonic treatment may be applied at the impaction chamber of the jet mill. Through the combination of the ultrasonic treatment and the impaction chamber of the jet mill, a high-density energy generated in the jet mill channel may promote a further expansion of the protein structure, and help a variety of proteins to be more efficiently recombined into a new composite protein. The particle size of the pulverized material may be no more than 50 μm, and the treatment capacity may be no less than 1 t/h, which is conducive to an industrial application of the plant protein modification. The emulsification and foaming performances of the treated composite protein may be improved, and the amino acid composition of the protein may be more reasonable. For example, the lysine content of the composite protein (4.41%) may be higher than the lysine content of the rice protein (2.8%), and a sulfur-containing amino acid content of the composite protein (1.65%) may be higher than the sulfur-containing amino acid content of pea protein (1.02%). In addition, the method provided by the embodiments of the present disclosure may have a green and simple treatment process, a high treatment efficiency in line with the industrial production standards, and can be applied in a continuous production.

### EMBODIMENTS

### Embodiment 1

A method of preparing a composite plant protein, specifically including the following steps.
(1) Pre-pulverizing: crude rice protein and pea protein were added to a cryogenic impact mill respectively and pre-pulverized to 300 mesh, and an air separator frequency was set at 40 Hz and a pulverizing temperature was 20° C.;
(2) Mixing: 0.3 t of the rice protein and 0.3 t of the pea protein from step (1), and 9.4 t of water at 45° C. were selected and added to a mixing tank with heat preservation to mix evenly to obtain a composite protein stock solution with a concentration of 6% (w/w);
(3) Alkali activation: the composite protein stock solution in step (2) was selected and treated with a compound alkaline powder. The compound alkaline powder was prepared by food-grade sodium hydroxide and calcium hydroxide at a ratio of 1:1 (w/w) to maintain a pH of the protein stock solution at 10.5;
(4) High-pressure jet mill-ultrasonic treatment: the protein stock solution prepared in step (3) was physically modified using an industrial-grade high-pressure jet mill, a motor frequency was adjusted to 22 Hz, a treatment pressure was controlled at 120 MPa, and an ultrasonic power was set at 300 W;
(5) Protein recombination: the modified protein stock solution in step (4) was selected, and food-grade citric acid was added to adjust the pH to 7.0 To induce the protein recombination, resulting in a material particle size of 30 μm;
(6) The neutralized protein solution in step (5) was selected for spray-drying to produce 0.45 t of composite plant protein with a solubility of 92%. A motor frequency of a mist drying tower atomizer was 45 Hz, an inlet air temperature was 180° C., and an outlet air temperature was 85° C.

### Embodiment 2

A method of preparing a composite plant protein, specifically including the following steps.
(1) Pre-pulverizing: crude rice protein and pea protein were added to a cryogenic impact mill respectively and pre-pulverized to 300 mesh, and an air separator frequency was set at 40 Hz and a pulverizing temperature was 18±1° C.;
(2) Mixing: 0.4 t of the rice protein and 0.4 t of the pea protein from step (1), and 9.2 t of water at 45° C. were selected and added to a mixing tank with heat preservation to mix evenly to obtain a composite protein stock solution with a concentration of 8% (w/w);
(3) Alkali activation: the composite protein stock solution in step (2) was selected and treated with a compound alkaline powder. The compound alkaline powder was prepared by food-grade sodium hydroxide and calcium hydroxide at a ratio of 1:1 (w/w) to maintain a pH of the protein stock solution at 10.5;
(4) High-pressure jet mill-ultrasonic treatment: the protein stock solution prepared in step (3) was physically modified using an industrial-grade high-pressure jet mill, a motor frequency was adjusted to 23 Hz, a treatment pressure was controlled at 130 MPa, and an ultrasonic power was set at 300 W;
(5) Protein recombination: the modified protein stock solution in step (4) was selected, and food-grade citric acid was added to adjust the pH to 7.0 to induce the protein recombination, resulting in a material particle size of 27 μm;
(6) The neutralized protein solution in step (5) was selected for spray-drying to produce 0.63 t of composite plant protein with a solubility of 91.7%. A motor frequency of a mist drying tower atomizer was 47 Hz, an inlet air temperature was 175° C., and an outlet air temperature was 80° C.

### Embodiment 3

A method of preparing a composite plant protein, specifically including the following steps.
(1) Pre-pulverizing: crude rice protein and pea protein were added to a cryogenic impact mill respectively and pre-pulverized to 300 mesh, and an air separator frequency was set at 40 Hz and an pulverizing temperature was 21±1° C.;
(2) Mixing: 0.25 t of the rice protein and 0.25 t of the pea protein from step (1), and 4.5 t of water at 45° C. were selected and added to a mixing tank with heat preservation to mix evenly to obtain a composite protein stock solution with a concentration of 10% (w/w);
(3) Alkali activation: the composite protein stock solution in step (2) was selected and treated with a compound alkaline powder. The compound alkaline powder was prepared by food-grade sodium hydroxide and calcium hydroxide at a ratio of 1:1 (w/w) to maintain a pH of the protein stock solution at 10;
(4) High-pressure jet mill-ultrasonic treatment: the protein solution prepared in step (3) was physically modified using an industrial-grade high-pressure jet mill, a motor frequency was adjusted to 22 Hz, a treatment pressure was controlled at 120 MPa, and an ultrasonic power was set at 300 W;
(5) Protein recombination: the modified stock protein solution in step (4) was selected, and food-grade citric acid was added to adjust the pH to 6.8 to induce the protein recombination, resulting in a material particle size of 33 μm;
(6) The neutralized protein solution in step (5) was selected for spray-drying to produce 0.38 t of composite plant protein with a solubility of 90.2%. A motor frequency of a mist drying tower atomizer was 43-45 Hz, an inlet air temperature was 180° C., and an outlet air temperature was 83° C.

### Comparative Embodiment 1

A method of preparing a composite plant protein, specifically including the following steps.
(1) Pre-pulverizing: crude rice protein and pea protein were added to a cryogenic impact mill respectively and pre-pulverized to 300 mesh, and an air separator frequency was set at 40 Hz and a pulverizing temperature was 23±1° C.;
(2) Mixing: 0.1 t of the rice protein and 0.1 t of the pea protein from step (1), and 1.8 t of water at 45° C. were selected and added to a mixing tank with heat preservation to mix evenly to obtain a composite protein stock solution with a concentration of 10% (w/w);
(3) Alkali activation: the composite protein stock solution in step (2) was selected and treated with a compound alkaline powder. The compound alkaline powder was prepared by food-grade sodium hydroxide and calcium hydroxide at a ratio of 1:1 (w/w) to maintain a pH of the protein stock solution at 10;
(4) Protein recombination: the modified protein stock solution in step (4) was selected, and food-grade citric acid was added to adjust the pH to 7.0 to induce the protein recombination, resulting in a material particle size of 55 μm;
(5) The neutralized protein solution in step (5) was selected for spray-drying to produce 0.1 t of composite plant protein with a solubility of 45.2%. A motor frequency of a mist drying tower atomizer was 48 Hz, an inlet air temperature was 180° C., and an outlet air temperature was 80° C.

### Comparative Embodiment 2

A method of preparing a composite plant protein, specifically including the following steps.
(1) Pre-pulverizing: crude rice protein and pea protein were added to a cryogenic impact mill respectively and pre-pulverized to 300 mesh, and an air separator frequency was set at 40 Hz and a pulverizing temperature was 23±1° C.;
(2) Mixing: 0.05 t of the rice protein and 0.05 t of the pea protein from step (1), and 0.9 t of water at 45° C. were selected and added to a mixing tank with heat preservation to mix evenly to obtain a composite protein stock solution with a concentration of 10% (w/w);
(3) High-pressure jet mill-ultrasonic treatment: the protein stock solution prepared in step (2) was physically modified using an industrial-grade high-pressure jet mill, a motor frequency was adjusted to 22 Hz, a processing pressure was controlled at 120 MPa, and an ultrasonic power was set at 300 W;
(4) The neutralized protein solution in step (3) was selected for spray-drying to produce 0.06 t of the composite plant protein with a solubility of 33.7%. The motor frequency of a mist drying tower atomizer was 46 Hz, an inlet air temperature was 180° C., and an outlet air temperature was 80° C.

### Comparative Embodiment 3

A method of preparing a composite plant protein, specifically including the following steps.
(1) Pre-pulverizing: crude rice protein and pea protein were added to a cryogenic impact mill respectively and pre-pulverized to 300 mesh, and an air separator frequency was set at 40 Hz and an pulverizing temperature was 21±1° C.;
(2) Mixing: 0.1 t of the rice protein and 0.1 t of the pea protein from step (1), and 1.8 t of water at 50° C. were selected and added to a mixing tank with heat preservation to mix evenly to obtain a composite protein stock solution with a concentration of 10% (w/w);
(3) Alkali activation: the composite protein stock solution in step (2) was selected and treated with a compound alkaline powder. The compound alkaline powder was prepared by food-grade sodium hydroxide and calcium hydroxide at a ratio of 1:1 (w/w) to maintain a pH of the protein stock solution at 10;
(4) High-pressure jet mill-ultrasonic treatment: the protein stock solution prepared in step (3) was physically modified using an industrial-grade high-pressure jet mill, a motor frequency was adjusted to 22 Hz, a processing pressure was controlled at 120 MPa;
(5) The neutralized protein solution in step (5) was selected for spray-drying to produce 0.12 t of the composite plant protein with a solubility of 65.5%. The motor frequency of a mist drying tower atomizer was 46 Hz, an inlet air temperature was 179° C., and an outlet air temperature was 81° C.

### Comparative Embodiment 4

A method of preparing a composite plant protein, specifically including the following steps.
(1) Pre-pulverizing: crude rice protein and pea protein were added to a cryogenic impact mill respectively and pre-pulverized to 300 mesh, and an air separator frequency was set at 40 Hz and a pulverizing temperature was 21±1° C.;
(2) Mixing: 0.01 t of the rice protein and 0.01 t of the pea protein from step (1), and 0.18 t of water at 45° C. were selected and added to a mixing tank with heat preservation to mix evenly to obtain a composite protein stock solution with a concentration of 10% (w/w);
(3) Alkali activation: the composite protein stock solution in step (2) was selected and treated with a compound alkaline powder. The compound alkaline powder was prepared by food-grade sodium hydroxide and calcium hydroxide at a ratio of 1:1 (w/w) to maintain a pH of the protein stock solution at 10;
(4) High-pressure jet mill-ultrasonic treatment: the protein stock solution prepared in step (3) was physically modified using an industrial-grade high-pressure jet mill, a motor frequency was adjusted to 22 Hz, a processing pressure was controlled at 120 MPa;
(5) Ultrasonic treatment: the composite protein stock solution from step (4) was selected for ultrasonic treatment alone, and an ultrasonic power was set at 300 W;
(6) The protein solution after ultrasonication in step (5) was selected for spray-drying to obtain the composite plant protein with a solubility of 67.8%, and a motor frequency of a mist drying tower atomizer was 46 Hz, an inlet air temperature was 181° C., and an outlet air temperature was 81° C.

### Embodiment 4

In the present embodiment, solubility, emulsification and foaming properties of the composite plant proteins prepared in Embodiments 1-3 and Comparative Examples 1-4 above were measured and analyzed, and a specific process was as follows.
(1) Determination of the solubility of composite protein: Kjeldahl method, an experimental process of which is referred to in GB 5009.5-2016.
(2) Determination of emulsification and emulsion stability of the composite protein:
The emulsification and the emulsion stability were determined by a turbidimetric method. 16 mL of the composite plant protein solution was taken, and 4 mL of soybean oil was added, and then immediately dispersed by a disperser to obtain an emulsion. Then 50 μL of the emulsion was immediately dispersed in 10 mL of 0.1% sodium dodecyl sulfate (SDS, w/v) at 0.5 cm from a bottom of a container by accurate measurement, then after a vortex mixing, absorbance values A₀ and A₁₀ of the emulsions after 0 min and 10 min were measured at a wavelength of 500 nm, respectively. An emulsification activity index (EAI, m²/g) and the emulsion stability index (ESI, min) were used to express the emulsification; the emulsification and the emulsion stability of the protein were calculated as follows:

$$EAI = \frac{2 \times 2.303 \times {A}_{0} \times DF}{C \times ( 1 - φ ) \times θ \times 10000}$$

where, DF denotes a dilution factor, C denotes a protein concentration (g/mL), φ denotes an optical path (1 cm), and θ denotes a volume fraction of oil (v/v).

$$ESI = \frac{{A}_{0} \times Δ t}{{A}_{0} - {A}_{10}}$$

where, A₀ denotes the absorbance value at 0 min; A₁₀ denotes the absorbance value after 10 min; Δt denotes a time difference.
(3) Determination of a foaming capacity and a foaming stability of the composite protein:
Composite protein solutions with different concentration ratios were precisely prepared at room temperature, dispersed by a disperser at 10,000 rpm for 1 min, and then rapidly transferred to a 100 mL measuring cylinder. Foaming volumes V₀ and V₂₀ were recorded at 0 min and 20 min, respectively, and the foaming capacity and the foaming stability of the protein were calculated as follows.

$$Foaming Capacity ( \% ) = \frac{{V}_{0}}{40} \times 100$$

$$Foaming Stability ( \% ) = \frac{{V}_{20}}{{V}_{0}} \times 100$$

Results of the above measurements were shown in Table 1:

TABLE 1
Determination results of the properties
of the composite plant proteins

| | Variant | | | | |
|---|---|---|---|---|---|
| | | Protein Emulsification | | | |
| | | Emulsifi- | | Protein Foaming | |
| | Protein | cation | Emulsion | Foaming | Foaming |
| Groups | Solubility | (m2/g) | Stability | Capacity | Stability |
| Embodiment | 87.1% | 18.39 | 39.39% | 145% | 74.16% |
| 1 | | | | | |
| Embodiment | 86.2% | 18.46 | 35.27% | 132.5% | 73.25% |
| 2 | | | | | |
| Embodiment | 85.3% | 17.32 | 36.84% | 140% | 70.32% |
| 3 | | | | | |
| Comparative | 42.2% | 12.22 | 31.56% | 90% | 85.33% |
| Embodiment | | | | | |
| 1 | | | | | |
| Comparative | 30.7% | 13.93 | 27.38% | 95.5% | 81.35% |
| Embodiment | | | | | |
| 2 | | | | | |
| Comparative | 65.5% | 16.97 | 36.28% | 125% | 75.55% |
| Embodiment | | | | | |
| 3 | | | | | |
| Comparative | 67.8% | 17.13 | 34.31% | 130% | 70% |
| Embodiment | | | | | |
| 4 | | | | | |
| Rice Protein | 1.37% | 7.09 | 14.60% | 47.5% | 84.76% |
| Sample | | | | | |
| Pea Protein | 6.33% | 10.22 | 28.18% | 50% | 90.27% |
| Sample | | | | | |
| Soy Protein | 11.91% | 11.56 | 27.34% | 89% | 87.29% |
| Sample | | | | | |

As may be seen from the above table, the protein recombination through a combination of a chemical modification and a physical modification (the high-pressure jet mill-ultrasonic treatment) substantially enhances the solubility of a composite protein of a rice protein-pea protein and a rice protein-soy protein by a factor of up to about 63.8, and enhances the emulsification by a factor of up to about 2.6, and enhances a foaming capacity by a factor of up to about 3, which substantially enhances functional properties of the rice protein and two types of legume proteins. In addition, if the high-pressure jet mill and the ultrasonic treatment are performed separately, the ultrasonic treatment is unable to enhance the properties of the composite plant protein.

In summary, under the embodiments of the present disclosure, the recombination of different plant proteins may be accomplished through the combination of the chemical modification and the physical modification (the high-pressure jet mill-ultrasonic treatment), the process can reach a standard of industrial-grade production, and the products may have excellent physicochemical properties and a wide range of application prospects.

The basic concepts have been described above, apparently, for those skilled in the art, and the above detailed descriptions do not constitute limitations of the present disclosure. Although there is no clear explanation here, those skilled in the art may make various modifications, improvements, and modifications of the present disclosure. These modifications, improvements, and corrections are recommended in the present disclosure, so these modifications, improvements, and amendments remain in the spirit and scope of the exemplary embodiment of the present disclosure.

At the same time, the present disclosure uses specific words to describe the embodiments of the present disclosure. As “one embodiment,” “an embodiment,” and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of the present disclosure are not necessarily all referring to the same embodiment. Further, certain features, structures, or features of one or more embodiments of the present disclosure may be combined.

In addition, unless clearly stated in the claims, the order of processing elements and sequences, the use of numbers and letters, or the use of other names in the present disclosure are not used to limit the order of the procedures and methods of the present disclosure. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, FIGURE, or description thereof for the purpose of streamlining the disclosure and aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities of ingredients, properties, and so forth, used to describe and claim certain embodiments of the application are to be understood as being modified in some instances by the terms “about,” “approximate,” or “substantially.” Unless otherwise stated, the “about,” “approximate,” or “substantially” may indicate ±20% variation of the value it describes. Accordingly, in some embodiments, the numerical parameters used in the present disclosure and the claims are approximate values, and the approximation may change according to the characteristics required by the individual embodiments. In some embodiments, the numerical parameter should consider the prescribed effective digits and adopt a general digit retention method. Although in some embodiments, the numerical fields and parameters used to confirm the breadth of its range are approximate values, in specific embodiments, such numerical values are set as accurately as possible within the feasible range.

With respect to each patent, patent application, patent application disclosure, and other material cited in the present disclosure, such as articles, books, manuals, publications, documents, etc., the entire contents thereof are hereby incorporated by reference into the present disclosure. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those described in the present disclosure, the descriptions, definitions, and/or use of terms in the present disclosure shall prevail.

At last, it should be understood that the embodiments described in the present disclosure are merely illustrative of the principles of the embodiments of the present disclosure. Other modifications that are employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for preparing a composite plant protein, comprising:
S1: mixing at least two kinds of plant proteins with water, adding compound alkali powder to a mixed solution and stirring, so as to obtain a protein stock solution with a pH of 10-10.5; wherein the two kinds of plant proteins are rice protein and pea protein, or the rice protein and soy protein; and the compound alkali powder is sodium hydroxide and calcium hydroxide;
S2: obtaining a protein solution with a pH of 6.8-7.0 by performing a high-pressure jet mill-ultrasonic treatment on the protein stock solution obtained from step S1, and adding citric acid to a treated protein stock solution; and
S3: obtaining the composite plant protein by spray-drying the protein solution obtained from step S2.

2. The method of claim 1, wherein step S1 is further preceded by a pre-treatment that includes pulverizing the at least two kinds of plant proteins to 300 mesh using a cryogenic impact mill; a frequency of the cryogenic impact mill being 40 Hz and a temperature of the cryogenic impact mill being 15° C.-25° C.

3. The method of claim 1, wherein a mass ratio of the sodium hydroxide to the calcium hydroxide is 1:1.

4. The method of claim 1, wherein a temperature of the water in step S1 is 45° C.-50° C.

5. The method of claim 1, wherein a ratio of the at least two kinds of plant proteins to the water is (0.6-1):(9-9.4).

6. The method of claim 1, wherein a mass ratio of the rice protein to the pea protein, or a mass ratio of the rice protein to the soy protein is 1:1.

7. The method of claim 1, wherein a frequency of the high-pressure jet mill in step S2 is 21 Hz-24 Hz and a pressure of the high-pressure jet mill is 120 MPa-160 MPa; and a power of the ultrasonic treatment is 300 W.

8. The method of claim 1, wherein a particle size of composite protein in the protein solution in step S2 is 25 μm-40 μm.

9. The method of claim 1, wherein the spray-drying in step S3 is performed using a mist drying tower atomizer at a frequency of 45 Hz-50 Hz, with an inlet air temperature of 160° C.-175° C. and an outlet air temperature of 75° C.-85° C.

10. A composite plant protein prepared by the method of claim 1.
